(19) United States
(12) Patent Application Publication
(10) Pub. No.: US 2015/0362403 A1
(43) Pub. Date: Dec. 17, 2015

(54) MEASUREMENT APPARATUS, MEASUREMENT METHOD, OPTICAL ELEMENT FABRICATION APPARATUS, AND OPTICAL ELEMENT

(71) Applicant: CANON KABUSHIKI KAISHA, Tokyo (JP)

(72) Inventor: Yoshiki Maeda, Utsunomiya-shi (JP)

(21) Appl. No.: 14/736,437

(22) Filed: Jun. 11, 2015

(30) Foreign Application Priority Data
Jun. 16, 2014 (JP) 2014-123051

(51) Int. Cl. G01M 11/02; G02B 3/02

(52) U.S. Cl. CPC G01M 11/0271; G01M 11/025; G02B 3/02

(57) ABSTRACT

A measurement apparatus configured to measure a shape or transmitted wavefront of an object surface includes an illumination optical system configured to irradiate the object surface with light from a light source as illumination light, an imaging optical system configured to guide reflected light beams or transmitted light beams from the object surface as detection light, a sensor disposed on an image plane of the imaging optical system and configured to detect the detection light guided by the imaging optical system, and a drive unit configured to change a distance between an entrance pupil of the imaging optical system and a sensor conjugate plane conjugate to the sensor with respect to the imaging optical system.

### BACKGROUND OF THE INVENTION

1. Field of the Invention

The present invention relates to a measurement apparatus that measures a surface shape and transmitted wavefront of an optical element (lens, for example).

2. Description of the Related Art

Reduction in the size of an optical apparatus and increase in the accuracy thereof have caused increase in the power of an optical element such as lens and mirror included in the optical apparatus and change thereof to an aspherical shape. Evaluation and manufacturing of the optical element involves measurement of the surface shape and wavefront of such an optical element. However, the wavefront (transmitted wavefront or reflected wavefront) of a high-power optical element (such as single lens and optical element whose aberration is not corrected) and an aspherical optical element has a large aberration amount (deviation amount from a spherical surface). Moreover, the curvature of the wavefront differs in a great range depending on the power (surface curvature) of an optical element. Thus, a measurement apparatus is required to measure wavefronts having various curvatures and large aberrations.

A surface shape measurement apparatus including a Fizeau interferometer is disclosed in Daniel Malacara, “Optical Shop Testing”, Sections 29 and 30, and FIGS. 1.30 and 1.31. The Fizeau interferometer performs measurement in a state in which the curvature of an object surface and the curvature of a wavefront incident on the object surface are identical to each other (the curvature center of the object surface and the condensing position of the incident wavefront are identical to each other) or close to each other. With this configuration, reflected light from the object surface and reflected light from a reference surface pass through optical paths close to each other, and thus the system error of the apparatus from an interference pattern is removed, thereby highly accurately calculating the shape of the object surface. Thus, in measurement of surfaces having different curvatures, an object is driven in an optical axis direction so that the incident wavefront and the curvature of the object surface coincide with each other. Consequently, the curvature of a wavefront passing through the reference surface has the curvature of the reference surface independently from the object, and the curvature of the wavefront where the interference pattern is formed is fixed independently from the object surface.

Japanese Patent Laid-open No. 2005-98933 discloses a transmitted wavefront measurement apparatus for an optical system including a Shack-Hartmann sensor having a large dynamic range. In a configuration disclosed in Japanese Patent Laid-open No. 2005-98933, a collimator lens is configured to be focused at the condensing position of a wavefront transmitted through a target optical system. Such a configuration removes a curvature component from the wavefront transmitted through the target optical system, thereby making collimated light incident on the sensor. Japanese Patent Laid-open No. 2003-42731 discloses a measurement apparatus that measures, by an interference method, the surface shape of an aspherical lens that generates a large aberration wavefront.

However, when a wavefront having a large aberration amount is measured by using the configurations disclosed in Daniel Malacara, “Optical Shop Testing”, Sections 29 and 30, and FIGS. 1.30 and 1.31, and Japanese Patent Laid-open No. 2005-98933, wavefronts incident on the optical system and the sensor of the measurement apparatus largely change compared to a case with no aberration. Thus, when a wavefront has a large aberration amount, light beams included in the wavefront overlap with each other before the wavefront travels to the sensor. Measurement of such a wavefront by the sensor cannot specify positions on the object surface based on incident light beams on the sensor because light beams from different positions on an object condense at identical points on the sensor (light-receiving portion).

A wavefront having a large aberration amount, that is, the wavefront having a large deviation (curvature component) from a spherical surface, travels on an optical path largely different from that of a wavefront having no aberration. This prevents the wavefront from entering a measurement optical system. Moreover, the diameter and angle of a light beam on the sensor become larger than allowable values by the light-receiving portion.

For this reason, the measurement apparatus disclosed in Japanese Patent Laid-open No. 2003-42731 includes an aspherical plate to solve the above-described problem by removing an aberration component from reflected wavefronts of an object incident on the measurement optical system and the sensor. However, the configuration disclosed in Japanese Patent Laid-open No. 2003-42731 needs to prepare an aspherical plate for each object, and is not versatile. In measurement of an object, it is required to measure objects having various powers without causing the above-described problem in measurement of a large aberration wavefront, that is, to simultaneously achieve an improved throughput and cost reduction.

### SUMMARY OF THE INVENTION

The present invention provides a high throughput and low cost measurement apparatus, measurement method, optical element fabrication apparatus, and optical element.

A measurement apparatus as one aspect of the present invention is a measurement apparatus configured to measure a shape or transmitted wavefront of an object surface. The measurement apparatus includes an illumination optical system configured to irradiate the object surface with light from a light source as illumination light, an imaging optical system configured to guide reflected light beams or transmitted light beams from the object surface as detection light, a sensor disposed on an image plane of the imaging optical system and configured to detect the detection light guided by the imaging optical system, and a drive unit configured to change a distance between an entrance pupil of the imaging optical system and a sensor conjugate plane conjugate to the sensor with respect to the imaging optical system.

A measurement method as another aspect of the present invention is a method of measuring a shape or transmitted wavefront of an object surface, the method including the steps of irradiating the object surface with light from a light source as illumination light and guiding reflected light beams or transmitted light beams from the object surface as detection light through an imaging optical system to a sensor disposed on an image plane of the imaging optical system, changing a distance between an entrance pupil of the imaging optical system and a sensor conjugate plane conjugate to the sensor with respect to the imaging optical system, and detecting, by the sensor, the detection light guided by the imaging optical system.

An optical element fabrication apparatus as another aspect of the present invention includes the measurement apparatus, and a fabrication unit configured to fabricate an optical element based on information from the measurement apparatus.

An optical element as another aspect of the present invention is manufactured by using the optical element fabrication apparatus.

Further features and aspects of the present invention will become apparent from the following description of exemplary embodiments with reference to the attached drawings.

### BRIEF DESCRIPTION OF THE DRAWINGS

FIG. 1 is a schematic configuration diagram of a wavefront measurement apparatus according to Embodiment 1 of the present invention.

FIGS. 2A and 2B are schematic configuration diagrams of the wavefront measurement apparatus according to Embodiment 1.

FIGS. 3A and 3B are schematic configuration diagrams of the wavefront measurement apparatus according to Embodiment 1.

FIGS. 4A to 4C are cross-sectional views of an imaging optical system according to Embodiment 1.

FIG. 5 is a flowchart of a wavefront measuring method according to Embodiment 1.

FIGS. 6A and 6B are schematic configuration diagrams of a wavefront measurement apparatus according to Embodiment 2 of the present invention.

FIG. 7 is an explanatory diagram of Conditional Expression (1).

FIG. 8 is a schematic configuration diagram of an optical element fabrication apparatus according to Embodiment 3 of the present invention.

### DESCRIPTION OF THE EMBODIMENTS

Exemplary embodiments of the present invention will be described below with reference to the accompanied drawings.

### Embodiment 1

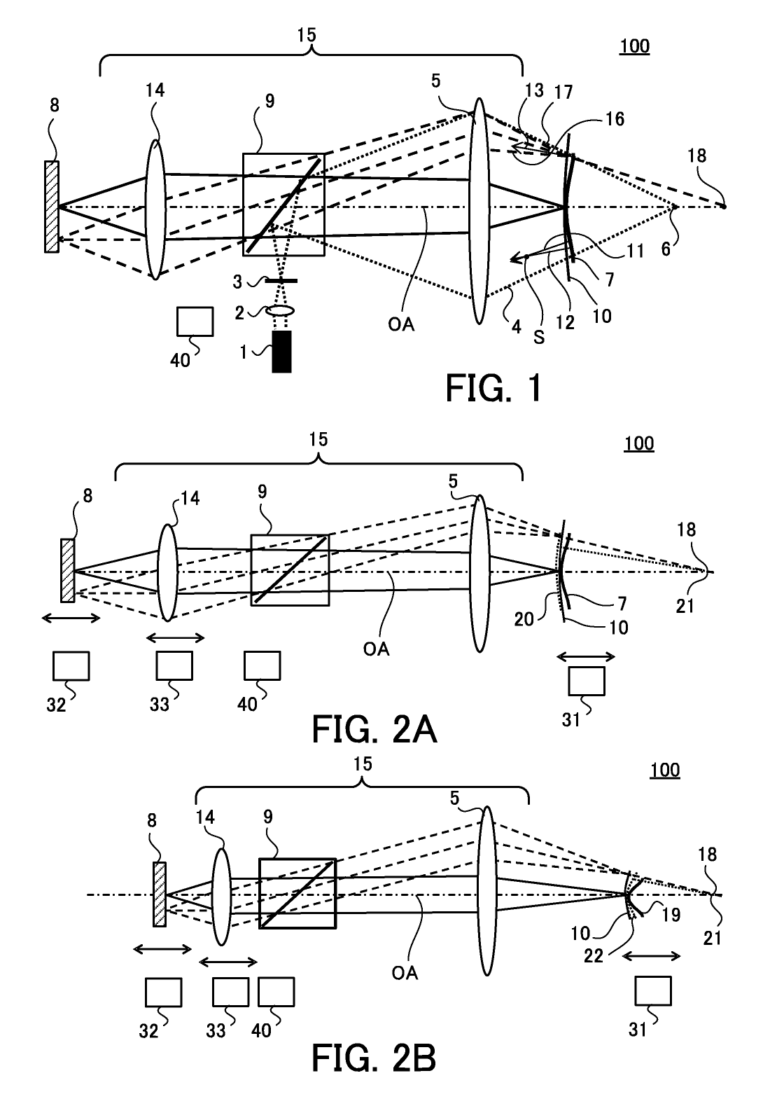

First, referring to FIG. 1, a schematic configuration of a wavefront measurement apparatus (aspherical surface measurement apparatus) according to Embodiment 1 of the present invention will be described. FIG. 1 is a schematic configuration diagram of a wavefront measurement apparatus 100 (measurement apparatus) according to the present embodiment.

Illumination light emitted from a light source 1 is incident on a pin hole 3 through a light condensing lens 2. A light beam emitted from the pin hole 3 is incident on a dichroic mirror 9 (light dividing unit). A light beam reflected by the dichroic mirror 9 is passed through an optical system 5 (illumination optical system) to be a converged spherical wave 4, which is then made incident on an object 7 (object surface) as illumination light. Reference numeral 6 denotes a condensing position of the illumination light from the optical system 5. Reference numerals 11, 12, and 13 each denote a light beam (reflected light or reflected light beams) reflected by the object 7. The reflected light (detection light) from the object 7, which is condensed through the optical system 5 and transmitted through the dichroic mirror 9, is incident on an optical system 14 (projection optical system). The reflected light is then condensed through the optical system 14 and is incident on a sensor 8 (detection unit). The wavefront measurement apparatus 100 measures reflected light (detection light) from the object 7 using the sensor 8, and calculates the surface shape (aspherical shape) of the object 7 using a controller 40 (calculation unit). The present embodiment uses a Shack-Hartmann sensor having a large dynamic range as the sensor 8. However, the present embodiment is not limited thereto, and a different kind of sensors may be used.

Next, a configuration for measuring a wavefront reflected by the object 7 through the sensor 8 will be described. In FIG. 1, the surface shape of the object 7 is aspherical. Thus, when irradiated with a spherical wave, the object 7 emits reflected light to which an aspherical component is added by the object 7, so that a reflected wavefront has a large aberration. In FIG. 1, the light beams 11, 12, and 13 represent some light beams included in a wavefront (large aberration wavefront) having a large aberration. The light beams 11 and 12 intersect with each other at a point S in FIG. 1. Thus, in the measurement by the sensor 8, reflected light beams from the object 7 may overlap with each other on the sensor 8. For this reason, the wavefront measurement apparatus 100 needs to be configured to perform the measurement in such a manner that the reflected light (light beams 11, 12, and 13) from the object 7 do not overlap with one another on the sensor 8.

Next, a condition for the light beams 11, 12, and 13 not to overlap with one another on the sensor 8 (no light beam overlapping) will be described. First, as illustrated in FIG. 1, the light beams 11, 12, and 13 reflected by the object 7 are transmitted through an imaging optical system 15 including the optical system 5, the dichroic mirror 9, and the optical system 14, and then are incident on the sensor 8. The imaging optical system 15 includes a light-receiving portion (such as CCD) of the sensor 8 as an image plane. The wavefront measurement apparatus 100 is configured such that a conjugate plane (sensor conjugate plane 10) of the sensor 8 with respect to the imaging optical system 15 is positioned closer to an object (on the right side in FIG. 1) than an intersection position (point S) of light beams (the light beams 11 and 12, for example) reflected at two points different from each other on the object 7. Such a configuration provides the reflected light from the object 7 as a wavefront having no light beam overlapping on the sensor conjugate plane 10, and a wavefront to be imaged on the sensor 8 through the imaging optical system 15 has no light beam overlapping, too. Placing the object 7 in such a way that a condition (condition for no light beam overlapping on the sensor 8) is satisfied is also described as “placing the object close to the sensor conjugate plane”.

The wavefront measurement apparatus 100 illustrated in FIG. 1 is an apparatus for measuring the shape of a convex surface. Thus, the imaging optical system 15 is designed so that the sensor conjugate plane 10 has a convex curvature, in other words, the curvature center of the sensor conjugate plane 10 is positioned on the right side of the object 7 in FIG. 1. Therefore, the Petzval sum of the imaging optical system 15 is preferably set so that the curvature of the sensor conjugate plane 10 and the curvature of a wavefront have the same sign, in other words, the sensor conjugate plane 10 and the wavefront of the illumination light or reflected light are convex toward the left side in FIG. 1.

In measurement of a wavefront having a large aberration, an optical path through the optical system (measurement optical system) and a wavefront incident on the sensor (referred to as a sensor incident wavefront) are largely different from those in measurement of an aplanatic wavefront. As a result, the wavefront having such a large aberration may not enter the measurement optical system, and the diameter and light beam angle of the sensor incident wavefront may be larger than allowable values received by the sensor. Thus, the wavefront measurement apparatus 100 needs to be configured to solve this problem in measurement of the wavefront having such a large aberration.

Description will be made with the light beam 13 in FIG. 1 as an example. In the present embodiment, the wavefront measurement apparatus 100 is configured so that the angle of the light beam 13 at a point where the light beam 13 passes through the sensor conjugate plane 10 is within an angle between a lower peripheral light beam 16 and an upper peripheral light beam 17 of the imaging optical system 15 (within an object side NA). In measurement of the wavefront having a large aberration, the condition described with the light beam 13 needs to be satisfied by all reflected light beams. Thus, the position of an entrance pupil 18 of the imaging optical system 15 is set so that angles of all light beams reflected by the object 7 at respective points where the light beams pass through the sensor conjugate plane 10 are within the angle (range) between the upper peripheral light beam 17 and the lower peripheral light beam 16. This condition ensures that a reflected wavefront from the object 7 enters the imaging optical system 15.

In the present embodiment, the maximum image height of the imaging optical system 15 is preferably set to be not larger than the size of the sensor 8 to allow measurement of all light beams incident on the sensor 8. Thus, the magnification of the imaging optical system 15 is set to be not larger than a value obtained by dividing the maximum image height by the radius of a measured region of the object 7. In the present embodiment, the sensor side principal ray of the imaging optical system 15 is telecentric, and the numerical aperture thereof is preferably set to be the sine of a maximum angle measurable by the sensor 8. Such a configuration allows a light beam passing through the edge of the pupil of the imaging optical system 15 to be incident on the sensor 8 at the measurable maximum angle. Thus, all light beams passing through the imaging optical system 15 can be measured by the sensor 8, and the optical system can be designed to be adapted to the dynamic range of the sensor 8. The configuration described above enables the wavefront measurement apparatus 100 to measure the wavefront having a large aberration.

Next, a configuration of the wavefront measurement apparatus 100, which is preferable for measuring large aberration wavefronts having curvatures different from one another, will be described. Measurement of an aspherical shape involves measurement of aspherical lenses having various central curvatures. A wavefront measurement apparatus such as an interferometer is configured to drive an object in the direction (optical axis direction) of an optical axis OA to make the curvature of an irradiation wavefront (illumination light) coincide with the curvature of the object, thereby dealing with a change in the curvature of the object. However, for an aspherical surface having a decreasing curvature toward the edge of the object 7 like the object 7 in FIG. 1, driving the object 7 away from the imaging optical system 15 causes light beams (for example, the light beams 11 and 12 in FIG. 1) to overlap with one another on the sensor conjugate plane 10. In this case, light beams on the sensor 8 overlap with one another, too, which makes it difficult to measure the shape of the object 7. For an aspherical surface having an increasing curvature toward the edge of the object 7, driving the object 7 closer to the imaging optical system 15 causes light beams to overlap with one another on the sensor conjugate plane 10, which makes it difficult to measure a wavefront. Thus, the configuration of the wavefront measurement apparatus 100 as illustrated in FIG. 1 is unable to deal with a change in the curvature of the object 7 by driving the object 7 in the optical axis direction in measurement of various aberration amounts.

With this configuration, in measurement of the object 7 having central curvatures different from one another (object having an aspherical surface), the curvature component of the reflected wavefront has different values depending on the object 7. This difference is reflected on a change in the angle of the reflected wavefront, and thus even when wavefronts have the same aberration amount, some reflected light may not travel within the range between the image side peripheral light beams of the imaging optical system 15 and may not enter the optical system, depending on the value of the curvature component. Thus, with the configuration of the wavefront measurement apparatus 100 illustrated in FIG. 1, a measurable aberration amount changes depending on the value of the curvature component of the object 7. This means that the aberration amount measurable by the wavefront measurement apparatus 100 is reduced.

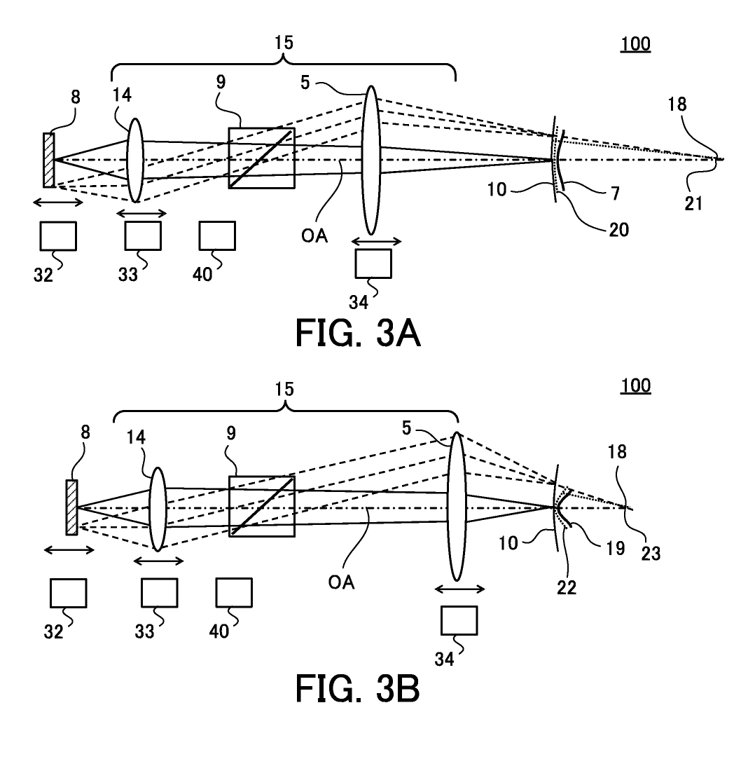

Next, referring to FIGS. 2A, 2B, 3A, and 3B, a configuration preferable for solving the above-described problem will be described. FIGS. 2A, 2B, 3A, and 3B are schematic configuration diagrams of the wavefront measurement apparatus 100. In FIGS. 2A, 2B, 3A, and 3B, the light source 1, the light condensing lens 2, and the pin hole 3, which are illustrated in FIG. 1, are omitted, but the object 7 and an object 19 are constantly irradiated with spherical waves. Arrows in FIGS. 2A, 2B, 3A, and 3B each indicates the direction of driving the object image point of optical elements or the imaging optical system 15.

FIG. 2A illustrates a configuration of the imaging optical system 15 in measurement of the object 7 having a small central curvature. FIG. 2B illustrates a configuration of the imaging optical system 15 in measurement of the object 19 having a large central curvature. In FIGS. 2A and 2B, reference numerals 20 and 22 denote curvature components of reflected wavefronts of the respective objects 7 and 19.

As illustrated in FIGS. 2A and 2B, the wavefront measurement apparatus 100 includes a drive unit 31. The drive unit 31 drives (moves) the objects 7 and 19 in the direction (optical axis direction) of the optical axis OA so that the curvatures of irradiation wavefronts (illumination light) incident on the objects 7 and 19 coincide or become closer to the curvatures of the objects 7 and 19, respectively. This keeps constant the curvatures of the reflected wavefronts of the objects 7 and 19, which are incident on the optical system 5. In other words, curvature centers 21 of the reflected wavefronts of the objects 7 and 19 are constantly at the same positions independent of the values of the curvature components of the objects 7 and 19.

As illustrated in FIGS. 2A and 2B, the wavefront measurement apparatus 100 includes a drive unit 32. The drive unit 32 drives (moves) the sensor 8 in the optical axis direction. This allows the sensor conjugate plane 10 to be positioned in accordance with the drive (movement) of the objects 7 and 19. As a result, the sensor conjugate plane 10 can be constantly formed (disposed) near the objects 7 and 19, which prevents the light beam overlapping from occurring on the sensor 8.

As illustrated in FIGS. 2A and 2B, the entrance pupil 18 of the imaging optical system 15 is disposed near the curvature center 21 of the reflected wavefront. Such a configuration makes the angle of the principal ray of the imaging optical system 15 on the sensor conjugate plane 10 substantially coincide with the angle of the curvature component of the reflected wavefront. Thus, when the values of the curvature components of the objects 7 and 19 change, the angle of the curvature component of the reflected wavefront incident on the imaging optical system 15 still substantially coincides with the angle of the principal ray. The situation meant by the wording “substantially coincide” is such that these angles not only precisely coincide with each other but also can be evaluated to be effectively coincide with each other.

Consequently, a condition that the reflected wavefront does not enter the imaging optical system 15 (condition that reflected light is incident within the range of object side peripheral light beams of the imaging optical system 15) does not depend on the curvature components of the objects 7 and 19, but depends the aberration amount (aspherical surface amount) of the reflected wavefront. In other words, since the sensor 8 receives parallel light in a case of an aplanatic wavefront, all the dynamic range of the sensor 8 can be used for measurement of the aberration amount of the wavefront.

Next, a positional relation between the entrance pupil 18 of the imaging optical system 15 and the curvature center 21 of the reflected wavefront of each of the objects 7 and 19 will be described. In the present embodiment, the entrance pupil 18 is disposed near the curvature center 21 of the reflected wavefront of each of the objects 7 and 19. This is equivalent (equal) to a situation that a distance d from an object plane (the sensor conjugate plane 10) to the curvature center 21 of the reflected wavefront of each of the objects 7 and 19 satisfies Conditional Expression (1) below.

$$\frac{ho}{tan ( θ m + asin ( NAo ) )} < d < \frac{ho}{tan ( θ m - asin ( NAo ) )} \qquad ( 1 )$$

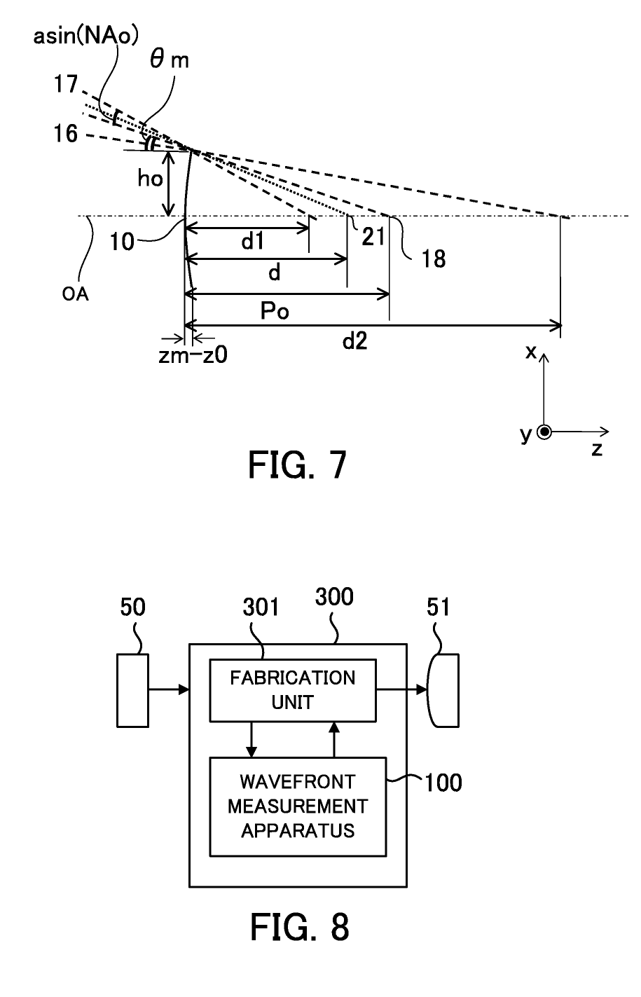

FIG. 7 is an explanatory diagram of Conditional Expression (1). In the following, referring to an xyz orthogonal coordinate system in illustrated in FIG. 7, the signs of reference numerals and positions in the optical system will be described.

In Conditional Expression (1), ho represents the maximum object height of the imaging optical system 15, NAo represents an object side numerical aperture, and θm represents the angle of the principal ray at the maximum object height with respect to the optical axis OA. θm is represented by Expression (2) below.

$$θ m = atan ( \frac{ho}{Po - Ro + \sqrt{{Ro}^{2} - {ho}^{2}}} ) \qquad ( 2 )$$

In Expression (2), Ro represents the curvature radius of the object plane (the sensor conjugate plane 10), and Po represents the distance from the object plane to the entrance pupil 18.

First, Expression (2) will be described. The imaging optical system 15 is configured so that the object plane (the sensor conjugate plane 10) is spherical. Thus, when the z coordinate of the maximum object height of the object plane is represented by zm, and the z coordinate of the object height on the optical axis OA is represented by z0, the values of zm and z0 are different from each other. The denominator in Expression (2) is a value obtained by subtracting the distance (zm−z0) between the z coordinates zm and z0 from the distance Po. The angle θm of the principal ray at the maximum object height ho with respect to the optical axis OA can be calculated through calculation of an arc tangent by dividing the maximum object height ho by the value.

The denominator (θm+a sin(NAo)) on the left-hand side of Conditional Expression (1) is the angle of the upper peripheral light beam 17 with respect to the optical axis OA. Thus, when the maximum object height ho is divided by the tangent of (θm+a sin(NAo)), the left-hand side of Conditional Expression (1) provides a distance d1 from the object plane (the sensor conjugate plane 10) to a point at which the upper peripheral light beam 17 intersects with the optical axis OA. The denominator (θm−a sin(NAo)) on the right hand side of Conditional Expression (1) is the angle of the lower peripheral light beam 16 with respect to the optical axis OA. Thus, when the maximum object height ho is divided by the tangent of (θm−a sin(NAo)), the right hand side of Conditional Expression (1) provides a distance d2 from the object plane (the sensor conjugate plane 10) to a point at which the lower peripheral light beam 16 intersects with the optical axis OA.

Conditional Expression (1) represents a condition that, for an aplanatic reflected wavefront of an object, a reflected light line passing at the maximum object height ho coincides with the upper peripheral light beam 17 of the imaging optical system 15 when the distance d coincides with the value on the left-hand side. Conditional Expression (1) is also a condition that a reflected light line passing at the maximum object height ho coincides with the lower peripheral light beam 16 of the imaging optical system 15 when the distance d coincides with the value on the right hand side. Thus, when the distance d does not satisfy Conditional Expression (1), the reflected light does not enter the imaging optical system 15. Hereinafter, the situation that the position of the entrance pupil 18 and the curvature center 21 of the reflected wavefront of the object satisfy Conditional Expression (1) is also described such that “the entrance pupil is disposed near the curvature center of the reflected wavefront”.

Next, a designing condition of the imaging optical system 15 to achieve the configurations of the wavefront measurement apparatus 100 illustrated in FIGS. 2A and 2B will be described. The wavefront measurement apparatus 100 in FIGS. 2A and 2B is configured such that the sensor conjugate plane 10 (object point) can be moved in accordance with the movement (drive by the drive unit 31) of each of the objects 7 and 19 by driving the sensor 8 (image point) in the optical axis direction by using the drive unit 32. This changes the magnification of the imaging optical system 15. In the present embodiment, the magnification change of the imaging optical system 15 is considered. Next, the relation of an imaging magnification with the distance between the entrance pupil 18 and the sensor conjugate plane 10 will be described.

First, a relation between the diameter of the object and the curvature of the reflected wavefront will be described. When the object has a large diameter, increasing the curvature of the object increases the thickness of a lens, which is a disadvantage in terms of glass material cost and weight reduction. Thus, when having a large diameter, the object often has a small curvature, and the reflected wavefront from such an object has a small curvature. On the other hand, when having a small diameter, the object often has a large curvature, and the reflected wavefront has a large curvature. Thus, when the reflected wavefront has a gentle curvature, in other words, the sensor conjugate plane and the entrance pupil 18 have a long distance therebetween, the object has a large diameter, and thus the diameter of the sensor conjugate plane 10 needs to be increased. In this case, the imaging optical system 15 is designed to have a reduced magnification. On the other hand, when the sensor conjugate plane 10 and the entrance pupil 18 have a short distance therebetween, the imaging optical system 15 is designed to have a large magnification.

Next, a designing condition related to the aberration of the imaging optical system 15 will be described. First, driving the sensor 8 in the optical axis direction changes the peripheral light beams of the imaging optical system 15, and changes the aberration. In particular, when the astigmatism of the imaging optical system 15 changes in accordance with the drive of the sensor 8, the sensor conjugate plane 10 and the object surface become separated from each other in a peripheral part of the object. Simultaneously, the light beam overlapping is generated on the sensor conjugate plane 10, which makes it difficult to measure a wavefront on the sensor 8. Thus, the imaging optical system 15 is preferably designed to reduce the change of the aberration in accordance with the drive of the sensor 8, in particular, the change of the astigmatism. As illustrated in FIGS. 2A and 2B, the wavefront measurement apparatus 100 includes a drive unit 33 that drives (moves) the optical system 14 in the optical axis direction. The drive unit 33 is used to drive the optical system 14 in the optical axis direction, thereby reducing (suppressing) the change of the aberration. The position of the pupil (aperture stop) of the imaging optical system 15 is preferably changed so that the sensor side principal ray is constantly telecentric.

The wavefront measurement apparatus 100 in FIGS. 2A and 2B is configured to drive the optical system 14 by using the drive unit 33 to reduce the change of the aberration, but is not limited thereto. The wavefront measurement apparatus 100 may include, instead of the drive unit 33, an increased number of optical elements (lenses) of the imaging optical system 15, or may include an aspherical lens to design an optical system having a smaller change of the aberration due to the drive (movement) of the sensor 8. With the configuration illustrated in FIGS. 2A and 2B, driving the object having a small curvature in the optical axis direction hardly changes the curvature of the reflected wavefront of the object. Thus, a design suitable for objects having various curvatures leads to a longer drive distance and a reduced diameter of the irradiation wavefront incident on the objects. Consequently, the measurable diameter of the objects is reduced.

Next, referring to FIGS. 3A and 3B, a configuration preferable for solving the above-described problem will be described. FIG. 3A illustrates a configuration of the imaging optical system 15 in measurement of the object 7 having a small central curvature. FIG. 3B illustrates a configuration of the imaging optical system 15 in measurement of the object 19 having a large central curvature.

In FIGS. 3A and 3B, reference numerals 20 and 22 respectively denote the curvature components of the reflected wavefronts of the objects 7 and 19. Reference numerals 21 and 23 respectively denote the curvature centers of the reflected wavefronts. The wavefront measurement apparatus 100 in FIGS. 3A and 3B does not drive the objects 7 and 19 in the optical axis direction (does not include the drive unit in FIGS. 2A and 2B), and thus the positions of the curvature centers 21 and 23 of the reflected wavefronts of the objects 7 and 19 are different from each other depending on the curvatures of the objects 7 and 19. The wavefront measurement apparatus 100 in FIGS. 3A and 3B changes the power configuration of lenses between the pupil (aperture stop) of the imaging optical system 15 and the objects so that the entrance pupil 18 is disposed near the curvature centers 21 and 23 of the reflected wavefronts. Such a configuration makes the angle of the principal ray of the imaging optical system 15 on the sensor conjugate plane 10 substantially coincide with the angles of the curvature components of the reflected wavefronts. In this manner, when the curvature components of the objects 7 and 19 change, the angles of the curvature components of the reflected wavefronts incident on the imaging optical system 15 still substantially coincide with the angle of the principal ray. Thus, a condition that the reflected wavefronts do not enter the imaging optical system 15 is determined by the aberration amounts of the objects 7 and 19 independently from the curvature components.

Next, a designing condition of the imaging optical system 15 to achieve the configurations of the wavefront measurement apparatus 100 illustrated in FIGS. 3A and 3B will be described. In the wavefront measurement apparatus 100 in FIGS. 3A and 3B, the entrance pupil 18 needs to be constantly disposed near the curvature centers 21 and 23 of the reflected wavefronts. As illustrated in FIGS. 3A and 3B, the wavefront measurement apparatus 100 includes a drive unit 34. The drive unit 34 is used to drive (move) the optical system 5 in the optical axis direction, thereby changing the power configuration of the lenses (optical system) between the pupil of the imaging optical system 15 and the objects 7 and 19. This allows the position of the entrance pupil 18 to be continuously changed, and thus objects having various curvatures can be dealt with. However, the change of the power of the optical system changes the imaging magnification. For the same reason as that explained with reference to FIGS. 2A and 2B, the imaging optical system 15 in FIGS. 3A and 3B is designed to have a small imaging magnification for a long distance between the sensor conjugate plane 10 and the entrance pupil 18, and on the other hand, to have a large imaging magnification for a short distance between the sensor conjugate plane 10 and the entrance pupil 18.

Driving the optical system 5 in the optical axis direction changes the peripheral light beams and the principal ray of the imaging optical system 15, and changes the aberration. Simultaneously, in the peripheral parts of the objects 7 and 19, the sensor conjugate plane 10 and the objects 7 and 19 (object surfaces) become separated from each other, and light beams overlap with one another on the sensor conjugate plane 10. In addition, the power of the imaging optical system 15 changes, and thus the position of the object image point changes. Similarly to the configurations in FIGS. 2A and 2B, the wavefront measurement apparatus 100 in FIGS. 3A and 3B is configured to drive the sensor 8 and the optical system 14 by using the drive units 32 and 33. This configuration can reduce (suppress) the change of the aberration and the change of the sensor conjugate plane 10 (object point). In addition, the position of the pupil of the imaging optical system 15 is changed so that the principal ray on the sensor side is constantly telecentric.

The wavefront measurement apparatus 100 in FIGS. 3A and 3B is configured as described above, but for the change of the sensor conjugate plane 10, the wavefront measurement apparatus 100 may drive the objects 7 and 19 by using the drive unit 31 in FIGS. 2A and 2B instead of driving the sensor 8 using the drive unit 32. The wavefront measurement apparatus 100 may include, instead of driving the optical system 14 using the drive unit 33, an increased number of lenses of the imaging optical system 15, or include an aspherical lens to design an optical system having a smaller change of the aberration due to the drive of the optical system 5.

As described above, the wavefront measurement apparatus 100 according to the present embodiment can move, by using the drive units, at least one of the optical element (the optical systems 5 and 14), the sensor 8, and the objects 7 and 19 that are included in part of the imaging optical system 15. This allows the distance between the sensor conjugate plane 10 and the entrance pupil 18 to be changed. Such a configuration allows any object to be dealt with by disposing the entrance pupil 18 near the position of the curvature center of the reflected wavefront while forming the sensor conjugate plane 10 near the object. Consequently, large aberration reflected wavefronts from objects having various curvatures can be measured by the sensor 8.

Next, a positional relation between the entrance pupil 18 of the imaging optical system 15 and the curvature centers 21 and 23 of the reflected wavefronts, in other words, a positional relation between the entrance pupil 18 and the objects 7 and 19, will be described. For a simplified discussion, the description will be made on how a wavefront (also referred to as a sensor incident wavefront) incident on the sensor 8 (sensor plane), not a wavefront on the sensor conjugate plane 10, changes in accordance with the positional relation between the entrance pupil 18 and the curvature centers 21 and 23 of the reflected wavefronts.

First, when the entrance pupil 18 and each of the curvature centers 21 and 23 of the reflected wavefronts coincide with each other, the angle of the principal ray on the sensor conjugate plane 10 and each of the angles of the curvature components of the reflected wavefronts coincide with each other. Thus, when the reflected wavefronts of the objects 7 and 19 are aplanatic, the sensor side principal ray is telecentric, and thus the sensor 8 receives parallel light. When the reflected wavefronts of the objects 7 and 19 have aberration, the sensor 8 measures the aberration values of the reflected wavefronts only.

On the other hand, when the entrance pupil 18 and each of the curvature centers 21 and 23 of the reflected wavefronts do not coincide with each other, the angle of the principal ray on the sensor conjugate plane 10 and each of the angles of the curvature components of the reflected wavefronts do not coincide with each other. Thus, when the reflected wavefronts are aplanatic, the sensor 8 does not receive parallel light, but receives a wavefront having a curvature component. Therefore, the curvature component of the sensor incident wavefront can be independently changed by having a variable distance between the entrance pupil 18 and each of the curvature centers 21 and 23 of the reflected wave fronts.

The capability of independently changing the curvature component of the sensor incident wavefront allows an optional curvature component to be added to the aberration component of the sensor incident wavefront. Specifically, a curvature component having a tilt of a sign opposite to that of the maximum tilt of the aberration component of the wavefront is added. Then, the maximum value of the angle of the aberration component incident on the sensor (also referred to as a sensor incident angle) is smaller as compared to a case in which the curvature component is not added. In this manner, the measurable aberration amount can be increased by adding the curvature component to the sensor incident wavefront to reduce the sensor incident angle.

The above description is made on the wavefront on the sensor 8, but the sensor 8 coincides with the image plane of the imaging optical system 15. Thus, the reduction of the angle of a light beam incident on the sensor is equivalent (equal) to reduction of the angle of a reflected light line of an object, which is incident on the sensor conjugate plane 10 corresponding to the object plane of the imaging optical system 15.

Next, a configuration for changing the distance between the entrance pupil 18 and each of the curvature centers 21 and 23 of the reflected wavefronts will be described. First, in the configure in FIGS. 2A and 2B, the power configuration of the lenses between the pupil of the imaging optical system 15 and each of the objects 7 and 19 does not change, and thus the position of the entrance pupil 18 does not change. Thus, the positions of the curvature center 21 of the reflected wavefront can be changed by driving the objects 7 and 19 in the optical axis direction to shift the curvature of the irradiation wavefront and the curvatures of the objects 7 and 19 from each other. This allows the distance between the entrance pupil 18 and the curvature center 21 of the reflected wavefront to be changed optionally. In the configurations in FIGS. 3A and 3B, the power configuration of the lenses between the pupil of the imaging optical system 15 and the objects 7 and 19 change, and thus the position of the entrance pupil 18 can be changed freely. This allows the distance between the entrance pupil and each of the curvature centers 21 and 23 of the reflected wavefronts to be changed optionally.

The above description is made on the condition on the imaging optical system 15 capable of measuring wavefronts having various curvatures and large aberrations. Next, referring to Table 1, a numerical example of the imaging optical system 15 to achieve this condition will be described. Table 1 lists data in the present embodiment. The imaging optical system 15 can change the distance between the sensor conjugate plane 10 and the entrance pupil 18 in a range from 600 mm to 300 mm. Table 1 lists the numerical example where the distance between the sensor conjugate plane 10 and the entrance pupil 18 is 600, 400, and 300 mm as representative values.

In Table 1, NAi represents the image side numerical aperture of the imaging optical system 15, hi represents the image height thereof. Surface numbers index the surfaces of the lenses in the optical system in order closest to the object in a direction in which a light beam travels, and r represents the curvature radius of each lens. d represents intervals between the surfaces, and three values in Table 1 are intervals when the distance between the sensor conjugate plane 10 and the entrance pupil 18 is 600, 400, and 300 mm. n represents the refractive index of an medium for a reference wavelength of 632.8 nm, and a refractive index of 1.000000 for air is omitted. In all the data below, the curvature radius r, the interval d, and other lengths are in millimeter [mm], which is a general notation, unless otherwise specified. However, an optical system provides an equal optical performance when the size thereof is proportionally increased or proportionally decreased, but is not limited to the notation.

TABLE 1
hi 10
NAi 0.17

| | r | d | n |
|---|---|---|---|
| Object | −500 | 56.41119 | |
| | | 62.11622 | |
| | | 149.9895 | |
| 1 | −564.05649 | 15 | 1.514621 |
| 2 | 540.713612 | 20 | |
| 3 | −140.01624 | 25 | 1.514621 |
| 4 | −115.25573 | 1 | |
| 5 | −1844.918 | 25 | 1.514621 |
| 6 | −174.92897 | 1 | |
| 7 | 168.019056 | 25 | 1.514621 |
| 8 | 48581.9632 | 108.9712 | |
| | | 143.941 | |
| | | 186.1853 | |
| 9 | Infinity | 80 | 1.514621 |
| 10 | Infinity | 39.6386 | |
| 11 | −50.639902 | 5 | 1.514621 |
| 12 | 409.843603 | 39.59751 | |
| 13 | −65.00583 | 5 | 1.514621 |
| 14 | −872.46809 | 32.33029 | |
| 15 | −186.36059 | 10 | 1.829396 |
| 16 | −86.1831 | 24.81825 | |
| 17 | 1393.07638 | 10 | 1.829396 |
| 18 | −204.20316 | 1 | |
| 19 | 202.618311 | 10 | 1.829396 |
| 20 | 413.649956 | 85.39447 | |
| 21 | 70.2117821 | 10 | 1.829396 |
| 22 | 96.0835407 | 100.5155 | |
| | | 99.78158 | |
| | | 85.82153 | |

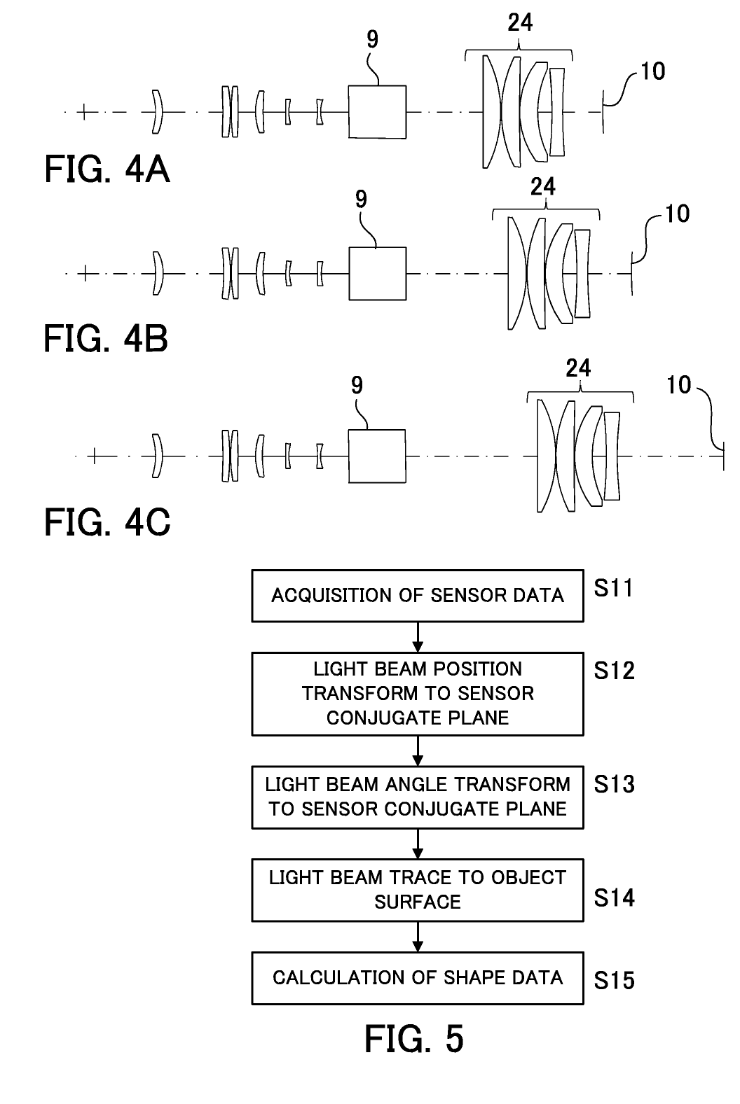

FIGS. 4A to 4C are each a sectional view (lens sectional view) of the optical system (the imaging optical system 15) whose data is listed in Table 1. FIGS. 4A to 4C are the sectional views when the distance between the sensor conjugate plane 10 and the entrance pupil is 600, 400, and 300 mm, respectively.

The optical system in FIGS. 4A to 4C also serves as a illumination system that irradiates an object with divergent light from a light source. Specifically, the ninth surface and the tenth surface (lens surfaces indexed in order closest to the right of FIGS. 4A to 4C) are each the dichroic mirror 9 that reflects the divergent light from the light source and makes the light incident on a lens unit 24 including the first surface to the eighth surface. The lens unit 24 is designed to have a positive refractive power. The lens unit 24 is thus configured to converge the divergent light from the light source and irradiate the object disposed on the object plane with the converged light.

The imaging optical system 15 including the first surface to the 22th surface in FIGS. 4A to 4C has such a characteristic that its Petzval sum is negative and the object plane (the sensor conjugate plane 10) is a spherical surface having a curvature radius of −500 mm. To achieve this, the imaging optical system 15 includes negative lenses having high powers and disposed on both sides of the pupil. Such a configuration can compensate (cancel) part of a coma generated through the negative lenses. In addition, the negative lenses are each formed of a glass material having a low refractive index, and positive lenses are each formed of a glass material having a high refractive index, which is a configuration to compensate the powers of the negative lenses and reduce any aberration generated by them. Such a configuration allows correction of the aberration of the imaging optical system 15 having a negative Petzval sum.

Next, referring to FIGS. 4A to 4C, a mechanism of the imaging optical system 15 for changing the distance between the sensor conjugate plane 10 and the entrance pupil 18 will be described. In FIGS. 4A to 4C, the lens unit 24 including the first surface to the eighth surface is driven so as to change the distance between the eighth surface (leftmost lens surface of the lens unit 24 in FIGS. 4A to 4C) and the ninth surface as a surface of the dichroic mirror 9 (right-side surface of the dichroic mirror 9). The lens unit 24 is driven by, for example, the drive unit 34 in FIGS. 3A and 3B. This drive changes the distance between the pupil and the lens unit 24 of the imaging optical system 15. The lens unit 24 has a positive refractive power and has its focal length set to be shorter than the distance between the pupil and the principal point of the lens unit 24. Thus, increasing the distance between the eighth surface and the ninth surface reduces the distance between the entrance pupil 18 and the first surface (lens surface nearest to the sensor conjugate plane 10). On the other hand, reducing the distance between the eighth surface and the ninth surface increases the distance between the entrance pupil 18 and the first surface. In FIGS. 4A to 4C, such a configuration allows the distance between the sensor conjugate plane 10 and the entrance pupil 18 of the imaging optical system 15 to be changed.

The imaging optical system in FIGS. 4A to 4C is configured to change the heights and incident angles of the peripheral light beams at each surface by changing the distance between the 22th surface and the image plane, thereby changing the aberration amount of the surface. The imaging optical system utilizes this configuration to cancel the change of the aberration of the imaging optical system due to a change of the distance between the eighth surface and the ninth surface. The drive described above changes the distance between the object plane and the first surface. As described above, the imaging optical system in FIGS. 4A to 4C is configured to drive the object in accordance with the translation of the object plane (the sensor conjugate plane 10), thereby keeping the object being constantly disposed near the sensor conjugate plane 10.

As described above, the imaging optical system in FIGS. 4A to 4C includes a drive unit (the drive unit 34, for example) for changing the distance between the sensor conjugate plane 10 and the entrance pupil 18 illustrated in FIGS. 2A, 2B, 3A, and 3B. Thus, the use of the optical system in FIGS. 4A to 4C and Table 1 allows measurement of wavefronts having various curvatures and large aberrations. Consequently, collective measurement of various aspherical shapes can be performed by a single wavefront measurement apparatus, thereby achieving high throughput and low cost of the wavefront measurement apparatus.

Next, referring to FIG. 5, a wavefront measuring method (measurement method of calculating the shape of an object from data measured by the sensor 8) according to the present embodiment will be described. FIG. 5 is a flowchart of the wavefront measuring method. Each step in FIG. 5 is executed by the controller 40 (refer to FIGS. 2A and 2B, FIGS. 3A and 3B) of the wavefront measurement apparatus 100.

First at step S11, the controller 40 acquires data (sensor data) of the shape of the object 7 (object surface) from the sensor 8 of the wavefront measurement apparatus 100. The sensor 8, which is the Shack-Hartmann sensor in the present embodiment, measures a light beam angle distribution as the sensor data, and outputs the measured light beam angle distribution to the controller 40.

Subsequently at step S12, the controller 40 transforms the light beam angle distribution obtained from the sensor 8 into the positions of light beams on the sensor conjugate plane 10 (performs a light beam position transform). At step S13, the controller 40 transforms the light beam angle distribution into the angles of the light beams on the sensor conjugate plane 10 (performs a light beam angle transform). In this manner, the controller 40 performs the light beam position transform and the light beam angle transform on the light beam angle distribution measured by the sensor 8 to transform the light beam angle distribution into an angle distribution of reflected light on the sensor conjugate plane 10. The light beam position transform transforms the position coordinates on the sensor plane into the position coordinates on the sensor conjugate plane 10. Specifically, the controller 40 uses paraxial magnification, lateral aberration, and distortion information of the imaging optical system 15 to calculate the position coordinates on the sensor conjugate plane 10 by dividing the position coordinates on the sensor plane by a magnification with aberration taken into account. The light beam angle transform transforms the light beam angle on the sensor into an angle on the sensor conjugate plane 10. Specifically, the controller 40 calculates the angle on the sensor conjugate plane 10 by multiplying the angle measured by the sensor 8 by an angle magnification with the aberration of the optical system taken into account.

Subsequently at step S14, the controller 40 performs a light beam trace from the sensor conjugate plane 10 to the object 7 (object surface), which is aspherical, to calculate an angle distribution of light beams reflected by the object 7. Finally at step S15, the controller 40 calculates the surface tilt of the object 7 from the angle distribution of reflected light on the object 7 and the angle distribution of illumination light, and calculates the shape of the object through integration of the surface tilt.

In the present embodiment, the controller 40 of the wavefront measurement apparatus 100 measures an object (reference object) whose shape is known and the object 7 whose shape is unknown, and processes measurement data of both objects in accordance with the flowchart in FIG. 5. Then, the controller 40 calculates a difference between two calculated surface shapes. This method removes a component in calculated surface shapes, which is generated due to a system error of the optical system, thereby increasing a surface measurement accuracy.

### Embodiment 2

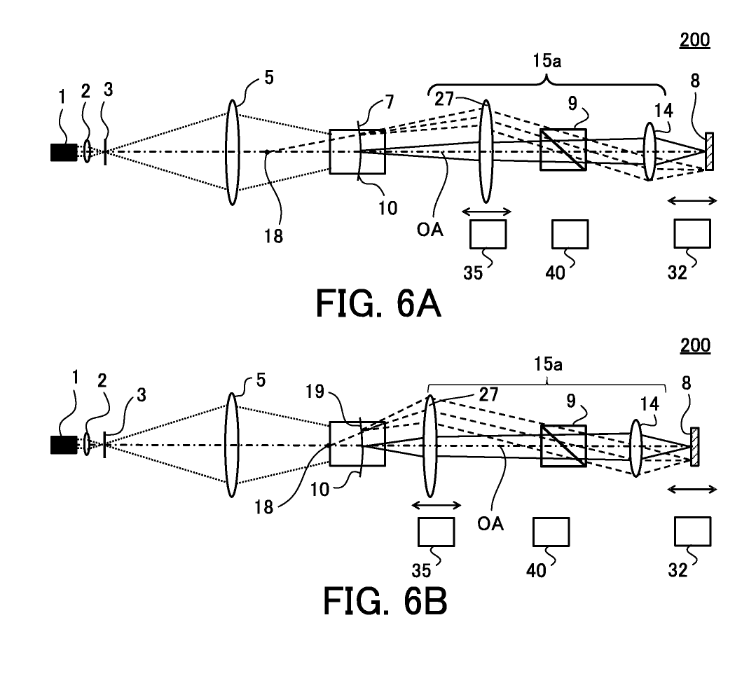

Next, referring to FIGS. 6A and 6B, a wavefront measurement apparatus according to Embodiment 2 of the present invention will be described. FIGS. 6A and 6B are schematic configuration diagrams of a wavefront measurement apparatus 200 (measurement apparatus) according to the present embodiment. The wavefront measurement apparatus 200 is configured to measure the transmitted wavefront (transmitted light or transmitted light beams as detection light) of an object.

Illumination light emitted from the light source 1 is incident on the pin hole 3 through the light condensing lens 2. A light beam emitted from the pin hole 3 passes through the optical system 5 (illumination optical system) and is converged into a spherical wave that is then made incident on the object 7. Then, a light beam transmitted through the object 7 is measured by the sensor 8 through an imaging optical system 15a (the optical systems 14 and 27 and the dichroic mirror 9), the controller 40 calculates the transmitted wavefront of the object 7. The present embodiment uses the Shack-Hartmann sensor having a large dynamic range as the sensor 8, but is not limited thereto.

FIG. 6A is a configuration diagram of the wavefront measurement apparatus 200 in measurement of the transmitted wavefront of the object 7 having a negative power whose absolute value is small. FIG. 6B is a configuration diagram of the wavefront measurement apparatus 200 in measurement of the transmitted wavefront of the object 19 having a power whose absolute value is large. In FIGS. 6A and 6B, the curvature components of incident wavefronts on the objects are not change, and thus the curvature of the transmitted wavefront of the object in FIG. 6B is larger than that in FIG. 6A. Consequently, the distance of the curvature center of the transmitted wavefront to the object in FIG. 6B is shorter that in FIG. 6A. In measurement of the transmitted wavefronts in the present embodiment, a condition to measure wavefronts having various curvatures and large aberrations is the same as in Embodiment 1. Thus, the imaging optical system 15a in FIGS. 6A and 6B has a variable distance between the entrance pupil 18 and the sensor conjugate plane 10 in FIGS. 2A, 2B, 3A, and 3B.

Next, a configuration of the wavefront measurement apparatus 200 in measurement of a transmitted wavefront having a large aberration will be described. The wavefront measurement apparatus 200 in FIGS. 6A and 6B is configured to have the sensor conjugate plane 10 formed at such a position that transmitted light beams from an object do not overlap with each other. Such a configuration can avoid the light beam overlapping on the sensor 8. The wavefront measurement apparatus 200 in FIGS. 6A and 6B is configured to drive, through a drive unit 35, the optical system 27, which is described referring to FIGS. 3A and 3B, between the pupil of the imaging optical system 15a and the objects 7 and 19, thereby changing the distance between the entrance pupil 18 and the sensor conjugate plane 10 of the imaging optical system 15a. This allows the entrance pupil 18 of the imaging optical system 15a to be disposed near the curvature center of the transmitted wavefront. Such a configuration allows any object to be dealt with by having the entrance pupil 18 of the imaging optical system 15a disposed near the curvature center of the transmitted wavefront while having the sensor conjugate plane 10 disposed near the object. Thus, the wavefront measurement apparatus 200 can measure large aberration transmitted wavefronts from objects having various powers.

In measurement of the transmitted wavefront using the wavefront measurement apparatus 200 in FIGS. 6A and 6B, the transforms (the wavefront measuring method) described referring to FIG. 5 are performed to remove the aberration of the imaging optical system 15a from a wavefront measured by the sensor 8, thereby acquiring the wavefront of the object. The controller 40 of the wavefront measurement apparatus 200 measures an object (reference object) whose aberration is known and an object whose shape is unknown, and calculates a difference between transmitted wavefronts thereof. Such a configuration allows a component in the wavefront, which is generated due to a system error of the optical system, to be removed, thereby achieving a high measurement accuracy.

### Embodiment 3

Next, referring to FIG. 8, an optical element fabrication apparatus according to Embodiment 3 of the present invention will be described. FIG. 8 is a schematic configuration diagram of an optical element fabrication apparatus 300 according to the present embodiment. The optical element fabrication apparatus 300 fabricates an optical element based on information from the wavefront measurement apparatus 100 in Embodiment 1 (or the wavefront measurement apparatus 200 in Embodiment 2).

In FIG. 8, reference numeral 50 denotes a material of a target lens, and reference numeral 301 denotes a fabrication unit that performs fabrication such as machining and polishing on the material 50 to manufacture a target lens as the optical element. The target lens 51 has an aspherical shape.

The surface shape of the target lens (an object surface) fabricated by the fabrication unit 301 is measured by the wavefront measuring method described in Embodiment 1 in the wavefront measurement apparatus 100 (or the wavefront measurement apparatus 200) as a measurement unit. Then, as described in Embodiment 1, in order to form the object surface in a target shape, the wavefront measurement apparatus 100 calculates a correction fabrication amount of the object surface based on a difference between measurement data of the surface shape of the object surface and target data, and outputs the calculated correction fabrication amount to the fabrication unit 301. Then, the fabrication unit 301 performs a correction fabrication on the object surface to complete the target lens having the object surface in the target shape.

As described above, the wavefront measurement apparatuses 100 and 200 in the embodiments are each a measurement apparatus that measures the shape or transmitted wavefront of the object surface, and includes the illumination optical system (optical system 5), the imaging optical systems 15 and 15a, the sensor 8, and the drive unit (drive units 31 to 35). The illumination optical system irradiates the object surface (object) with light from the light source 1 as illumination light. The imaging optical system guides, as detection light, reflected light or transmitted light from the object surface. The sensor is disposed on the image plane of the imaging optical system, and detects the detection light guided by the imaging optical system. The drive unit changes a distance between the entrance pupil 18 of the imaging optical system and the sensor conjugate plane 10 conjugate to the sensor with respect to the imaging optical system, i.e. the sensor conjugate plane 10 conjugate to the sensor via the imaging optical system.

The drive unit preferably moves at least one of the optical element (the optical systems 5, 14, and 27) included in the imaging optical system, the object, and the sensor, in the optical axis direction so that the sensor conjugate plane is formed at a position where reflected light beams or transmitted light beams do not intersect with one another (that is, a position near the object). The drive unit preferably moves at least one of the optical element (the optical systems 5, 14, and 27) included in the imaging optical system, the object, and the sensor, in the optical axis direction to change the curvature component of the wavefront of the detection light. The drive unit preferably changes the curvature component of the wavefront of the detection light to reduce the tilt of the wavefront of the detection light incident on the sensor. The drive unit more preferably provides a curvature component having a tilt of a sign opposite to that of the maximum tilt of the aberration component of the wavefront of the detection light incident on the sensor, by moving at least one of the optical element, the object, and the sensor. The “curvature component having a tilt of a sign opposite to that of the maximum tilt of the aberration component” is a curvature component having a negative tilt for a positive maximum tilt of the aberration component and a positive tilt for a negative maximum tilt.

The imaging optical system is preferably configured such that a sensor side principal ray of the imaging optical system is telecentric. The imaging optical system is preferably configured such that a sensor side numerical aperture of the imaging optical system is the sine of a maximum light beam angle measurable by the sensor. The entrance pupil of the imaging optical system and the curvature center of the wavefront right after reflected or transmitted from the object are preferably positioned on an identical side of the object in the optical axis direction. The imaging optical system is preferably configured not to have vignetting (not to prevent reflected light or transmitted light from entering the imaging optical system) when the distance between the entrance pupil and the sensor conjugate plane is changed by the drive unit.

The imaging optical system is preferably configured such that the absolute value of the lateral magnification of the imaging optical system is reduced when the distance between the entrance pupil and the sensor conjugate plane is increased. The measurement apparatus preferably further includes the calculation unit (controller 40) that calculates the shape of the object surface based on the detection light detected by the sensor. The drive unit is preferably configured to change the distance between the entrance pupil of the imaging optical system and the object surface.

The configuration according to each of the embodiments can measure a wavefront having a large aberration, independently from the value of the curvature component of the wavefront, and can achieve an increased measurable aberration amount. The configuration allows various aspherical shapes and large aberration transmitted wavefronts to be collectively measured by a single wavefront measurement apparatus without a correction optical system. Thus, each of the embodiments can provide a measurement apparatus, a measurement method, an optical element fabrication apparatus, and an optical element that achieve a high throughput and low cost.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For example, the wavefront measurement apparatus according to each of the embodiments is configured to measure a divergent wave from an object. However, the wavefront measurement apparatus is not limited thereto, and may be configured to measure a convergent wave from the object. In this case, the entrance pupil may be positioned closer to the imaging optical system than the sensor conjugate plane, and the imaging optical system may change the distance between the sensor conjugate plane and the entrance pupil.

The wavefront measurement apparatus according to each of the embodiments irradiates an object with a spherical wave, but may irradiate the object with a wavefront having aberration. In the numerical example in Table 1, all elements of the optical system that are disposed between the dichroic mirror and the object are driven, but only part of the optical system may be driven. In Embodiment 2, the object is fixed, but the object may be driven in the optical axis direction in accordance with the power of the object, while the position of the curvature center of transmitted wavefront is fixed. In this case, the imaging optical system 15 to be passed through after the object may be the imaging optical system described referring to FIGS. 2A and 2B. Alternatively, the object is driven in the optical axis direction, while the position of the curvature center of the transmitted wavefront may not be fixed. In this case, the imaging optical system 15 to be passed through after the object may be the imaging optical system (imaging optical system in FIGS. 4A to 4C) in combination with the imaging optical system described referring to FIGS. 2A, 2B, 3A, and 3B.

The sensor 8 is not limited to the Shack-Hartmann sensor, and may be a wavefront sensor such as Talbot interferometer and shearing interferometer. The calculation of a shape from data measured by the sensor 8 may perform a light beam trace using lens data reflected on an optical CAD, without performing at least part of the steps illustrated in FIG. 5, to calculate the light beam angle on the object.

This application claims the benefit of Japanese Patent Application No. 2014-123051, filed on Jun. 16, 2014, which is hereby incorporated by reference wherein in its entirety.

What is claimed is:

1. A measurement apparatus configured to measure a shape or transmitted wavefront of an object surface, the apparatus comprising:
an illumination optical system configured to irradiate the object surface with light from a light source as illumination light;
an imaging optical system configured to guide reflected light beams or transmitted light beams from the object surface as detection light;
a sensor disposed on an image plane of the imaging optical system and configured to detect the detection light guided by the imaging optical system; and
a drive unit configured to change a distance between an entrance pupil of the imaging optical system and a sensor conjugate plane conjugate to the sensor with respect to the imaging optical system.

2. The measurement apparatus according to claim 1, wherein
the sensor conjugate plane is formed at a position where the reflected light beams or the transmitted light beams do not intersect with one another.

3. The measurement apparatus according to claim 1, wherein
the drive unit is configured to move at least one of an optical element included in the imaging optical system and the sensor in an optical axis direction so as to change a curvature component of a wavefront of the detection light.

4. The measurement apparatus according to claim 3, wherein
the drive unit is configured to change the curvature component of the wavefront of the detection light so as to reduce a tilt of a wavefront of the detection light incident on the sensor.

5. The measurement apparatus according to claim 4, wherein
the drive unit is configured to move at least one of the optical element and the sensor so as to provide a curvature component having a tilt with a sign opposite to a sign of a maximum tilt of an aberration component of the wavefront of the detection light incident on the sensor.

6. The measurement apparatus according to claim 1, wherein
the imaging optical system is configured such that a sensor side principal ray of the imaging optical system is telecentric.

7. The measurement apparatus according to claim 1, wherein
the imaging optical system is configured such that a sensor side numerical aperture of the imaging optical system is a sine of a maximum light beam angle measurable by the sensor.

8. The measurement apparatus according to claim 1, wherein
the entrance pupil of the imaging optical system and a curvature center of a wavefront right after reflected or transmitted from the object surface are positioned on an identical side of the object surface in an optical axis direction.

9. The measurement apparatus according to claim 1, wherein
the imaging optical system is configured not to have vignetting when the drive unit changes a distance between the entrance pupil and the sensor conjugate plane.

10. The measurement apparatus according to claim 1, wherein
the imaging optical system is configured such that an absolute value of a lateral magnification of the imaging optical system is reduced when a distance between the entrance pupil and the sensor conjugate plane is increased.

11. The measurement apparatus according to claim 1, further comprising
a calculation unit configured to calculate a shape of the object surface based on the detection light detected by the sensor.

12. The measurement apparatus according to claim 1, wherein
the drive unit is configured to change a distance between the entrance pupil of the imaging optical system and the object surface.

13. A method of measuring a shape or transmitted wavefront of an object surface, the method comprising the steps of:
irradiating the object surface with light from a light source as illumination light and guiding reflected light beams or transmitted light beams from the object surface as detection light through an imaging optical system to a sensor disposed an image plane of the imaging optical system;
changing a distance between an entrance pupil of the imaging optical system and a sensor conjugate plane conjugate to the sensor with respect to the imaging optical system; and
detecting, by the sensor, the detection light guided by the imaging optical system.

14. The measurement method according to claim 13, further comprising the step of:
calculating the shape of the object surface based on the detection light detected by the sensor.

15. An optical element fabrication apparatus comprising:
the measurement apparatus according to claim 1; and
a fabrication unit configured to fabricate an optical element based on information from the measurement apparatus.

16. An optical element manufactured by using the optical element fabrication apparatus according to claim 15.
